(19) United States
(12) Patent Application Publication
(10) Pub. No.: US 2025/0216724 A1
(43) Pub. Date: Jul. 3, 2025

(54) REFLECTIVE LIQUID CRYSTAL DISPLAY DEVICE

(71) Applicant: Sharp Display Technology Corporation, Kameyama City (JP)

(72) Inventors: Ryosuke SAIGUSA, Kameyama City (JP); Naru USUKURA, Kameyama City (JP); Akiko MIYAZAKI, Kameyama City (JP); Akira SAKAI, Kameyama City (JP); Yuichi KAWAHIRA, Kameyama City (JP); Kiyoshi MINOURA, Kameyama City (JP)

(21) Appl. No.: 18/962,098

(22) Filed: Nov. 27, 2024

(30) Foreign Application Priority Data
Dec. 27, 2023 (JP) 2023-220677

(51) Int. Cl. G02F 1/13363; G02F 1/1335

(52) U.S. Cl. CPC G02F 1/133638; G02F 1/133504; G02F 1/133528; G02F 1/133618; G02F 2203/02

(57) ABSTRACT

Provided is a reflective liquid crystal display device that can exhibit increased light use efficiency. The reflective liquid crystal display device includes a reflective liquid crystal panel and an optical element disposed on or above an observer side of the reflective liquid crystal panel and including a polarizer and a Pancharatnam-Berry phase diffraction grating. For example, the optical element may include, in order from its reflective liquid crystal panel side toward its observer side, the polarizer, a λ/4 plate, and the Pancharatnam-Berry phase diffraction grating. The Pancharatnam-Berry phase diffraction grating may include a phase difference layer that introduces a phase difference Δnd satisfying the following Formula 1 or Formula 2 to wavelengths λ of 450 nm, 550 nm, and 650 nm.

$${sin}^{4} ( \frac{Δ nd π}{λ} ) > \frac{1}{4 π} \qquad ( Formula 1 )$$

$${sin}^{2} ( \frac{Δ nd π}{λ} ) {cos}^{2} ( \frac{Δ nd π}{λ} ) > \frac{1}{4 π} \qquad ( Formula 2 )$$

### CROSS-REFERENCE TO RELATED APPLICATIONS

The present application claims priority under 35 U.S.C. § 119 to Japanese Patent Application No. 2023-220677 filed on Dec. 27, 2023, the contents of which are incorporated herein by reference in their entirety.

### BACKGROUND OF THE INVENTION

### Field of the Invention

The following disclosure relates to reflective liquid crystal display devices.

### Description of Related Art

A technique relating to reflective liquid crystal display devices disclosed in JP 2006-317599 A is a reflector including a substrate, an uneven layer disposed on the substrate and having repeating uneven portions, and a light reflective layer covering the uneven layer, wherein the uneven portions of the uneven layer are formed by arranging bumps or recesses in a given direction, each of the bumps or recesses is in an arc pattern such as a circular arc or elliptical arc pattern, and the centerline which halves the opening angle of each arc pattern is oriented in the given direction.

### BRIEF SUMMARY OF THE INVENTION

The present invention aims to provide a reflective liquid crystal display device that can exhibit increased light use efficiency.

(1) One embodiment of the present invention is directed to a reflective liquid crystal display device including: a reflective liquid crystal panel; and an optical element disposed on or above an observer side of the reflective liquid crystal panel and including a polarizer and a Pancharatnam-Berry phase diffraction grating.

(2) In an embodiment of the present invention, the reflective liquid crystal display device includes the structure (1), and the optical element includes, in order from its reflective liquid crystal panel side toward its observer side, the polarizer, a λ/4 plate, and the Pancharatnam-Berry phase diffraction grating.

(3) In an embodiment of the present invention, the reflective liquid crystal display device includes the structure (2), and the polarizer is a linear polarizer or a circular polarizer.

(4) In an embodiment of the present invention, the reflective liquid crystal display device includes the structure (1), and the optical element includes, in order from its reflective liquid crystal panel side toward its observer side, a λ/4 plate, the Pancharatnam-Berry phase diffraction grating, and a circular polarizer as the polarizer.

(5) In an embodiment of the present invention, the reflective liquid crystal display device includes the structure (1), the optical element includes, in order from its reflective liquid crystal panel side toward its observer side, the Pancharatnam-Berry phase diffraction grating, and a circular polarizer as the polarizer, and does not include a λ/4 plate between the reflective liquid crystal panel and the Pancharatnam-Berry phase diffraction grating.

(6) In an embodiment of the present invention, the reflective liquid crystal display device includes the structure (1), (2), (3), (4), or (5), the Pancharatnam-Berry phase diffraction grating includes a phase difference layer containing a cured product of a polymerizable liquid crystal, a slow axis of the polymerizable liquid crystal, in a plane of the phase difference layer, rotates periodically in an x-axis direction from a first end to a second end of the phase difference layer and does not rotate periodically in a y-axis direction orthogonal to the x-axis direction, and the x-axis direction corresponds to a left-right direction of the reflective liquid crystal panel.

(7) In an embodiment of the present invention, the reflective liquid crystal display device includes the structure (1), (2), (3), (4), (5), or (6), the Pancharatnam-Berry phase diffraction grating includes a phase difference layer that introduces a phase difference Δnd satisfying the following Formula 1 or Formula 2 to wavelengths λ of 450 nm, 550 nm, and 650 nm.

$${sin}^{4} ( \frac{Δ nd π}{λ} ) > \frac{1}{4 π} \qquad ( Formula 1 )$$

$${sin}^{2} ( \frac{Δ nd π}{λ} ) {cos}^{2} ( \frac{Δ nd π}{λ} ) > \frac{1}{4 π} \qquad ( Formula 2 )$$

(8) In an embodiment of the present invention, the reflective liquid crystal display device includes the structure (1), (2), (3), (4), (5), (6), or (7), the Pancharatnam-Berry phase diffraction grating includes a phase difference layer containing a cured product of a polymerizable liquid crystal, a slow axis of the polymerizable liquid crystal, in a plane of the phase difference layer, rotates periodically in an x-axis direction from a first end to a second end of the phase difference layer, and a molecular alignment pattern Φ(x) [°] as an alignment direction of the polymerizable liquid crystal at a position a distance x [μm] away in the x-axis direction from a position where the slow axis of the polymerizable liquid crystal is parallel to the x-axis direction satisfies the following Formula 3:

$$∅ ( x ) = \frac{180 °}{Λ} x + m sin ( nx + A ) \qquad ( Formula 3 )$$

wherein Λ represents a pitch [μm] at which the slow axis of the polymerizable liquid crystal rotates 180° in the plane of the phase difference layer, and m, n, and A are each an arbitrary constant.

(9) In an embodiment of the present invention, the reflective liquid crystal display device includes the structure (1), (2), (3), (4), (5), (6), (7), or (8), and further includes a diffusion layer in the observer side of the optical element or between members constituting the optical element.

(10) In an embodiment of the present invention, the reflective liquid crystal display device includes the structure (1), (2), (3), (4), (5), (6), (7), (8), or (9), and further includes a refractive element in the observer side of the optical element.

The present invention can provide a reflective liquid crystal display device that can exhibit increased light use efficiency.

### BRIEF DESCRIPTION OF THE DRAWINGS

FIG. 1A is a schematic cross-sectional view of a reflective liquid crystal display device of Embodiment 1.

FIG. 1B is a schematic cross-sectional view of an example of a polarizer included in the reflective liquid crystal display device of Embodiment 1.

FIG. 1C is a schematic cross-sectional view of an example of a polarizer included in the reflective liquid crystal display device of Embodiment 1.

FIG. 2 is a schematic view illustrating a case where a common reflective liquid crystal display device is used for mobile purposes.

FIG. 3 is a schematic view illustrating a case where a common reflective liquid crystal display device is used in a wall-mounted configuration, for example.

FIG. 4 is a schematic cross-sectional view illustrating a case where a common reflective liquid crystal display device including a diffusion layer is used in a wall-mounted configuration, for example.

FIG. 5 is a schematic cross-sectional view of a reflective liquid crystal panel included in the reflective liquid crystal display device of Embodiment 1.

FIG. 6 is a diagram showing the molecular alignment of a polymerizable liquid crystal on a polarizing micrograph of a PBP diffraction grating included in the reflective liquid crystal display device of Embodiment 1.

FIG. 7 is a schematic cross-sectional view of the PBP diffraction grating included in the reflective liquid crystal display device of Embodiment 1.

FIG. 8 is a schematic view illustrating polarization dependence of the PBP diffraction grating included in the reflective liquid crystal display device of Embodiment 1.

FIG. 9 is a schematic plan view of the PBP diffraction grating included in the reflective liquid crystal display device of Embodiment 1.

FIG. 10 is a schematic cross-sectional view showing the white display state of a reflective liquid crystal display device of Embodiment 2.

FIG. 11 is a schematic cross-sectional view showing the black display state of the reflective liquid crystal display device of Embodiment 2.

FIG. 12 is a schematic cross-sectional view of a reflective liquid crystal display device of Embodiment 3.

FIG. 13 is a schematic view showing a step of forming a coating to serve as an alignment film in a method for producing a PBP diffraction grating in a reflective liquid crystal display device of Modified Example 1 of Embodiments 1 to 3.

FIG. 14 is a schematic view showing a first photoirradiation step in the method for producing the PBP diffraction grating in the reflective liquid crystal display device of Modified Example 1 of Embodiments 1 to 3.

FIG. 15 is a schematic view showing a second photoirradiation step in the method for producing the PBP diffraction grating in the reflective liquid crystal display device of Modified Example 1 of Embodiments 1 to 3.

FIG. 16 is a schematic view showing a third photoirradiation step in the method for producing the PBP diffraction grating in the reflective liquid crystal display device of Modified Example 1 of Embodiments 1 to 3.

FIG. 17 is a schematic view showing a fourth photoirradiation step in the method for producing the PBP diffraction grating in the reflective liquid crystal display device of Modified Example 1 of Embodiments 1 to 3.

FIG. 18 is a schematic view showing a baking step in the method for producing the PBP diffraction grating in the reflective liquid crystal display device of Modified Example 1 of Embodiments 1 to 3.

FIG. 19 is a schematic view showing a step of forming a film of a polymerizable liquid crystal in the method for producing the PBP diffraction grating in the reflective liquid crystal display device of Modified Example 1 of Embodiments 1 to 3.

FIG. 20 is a schematic view showing the step of forming a film of a polymerizable liquid crystal in the method for producing the PBP diffraction grating in the reflective liquid crystal display device of Modified Example 1 of Embodiments 1 to 3.

FIG. 21 is a schematic view showing a step of curing the polymerizable liquid crystal in the method for producing the PBP diffraction grating in the reflective liquid crystal display device of Modified Example 1 of Embodiments 1 to 3.

FIG. 22 is a schematic cross-sectional view of a reflective liquid crystal display device of Modified Example 2 of Embodiments 1 to 3.

FIG. 23 is a schematic cross-sectional view illustrating the state of light in a reflective liquid crystal display device of Modified Example 3 of Embodiments 1 to 3.

FIG. 24 includes schematic views illustrating the difference between a diffractive element and a refractive element.

FIG. 25 is a schematic cross-sectional view illustrating the state of light in the reflective liquid crystal display device of Embodiment 1.

FIG. 26 is a schematic perspective view of a lenticular lens.

FIG. 27A is a schematic cross-sectional view of a verification device of Example 1.

FIG. 27B is a schematic view showing a method for measuring an angle of incidence and an angle of emergence using a large-area rotating breadboard.

FIG. 28 is a diagram illustrating generation of zero-order light.

FIG. 29 is a schematic cross-sectional view illustrating the state of light in a reflective liquid crystal display device of Example 2.

FIG. 30 is a schematic view illustrating an angle of diffraction θ of a PBP diffraction grating and light intensity distribution U (θ) on a screen.

FIG. 31 is a graph showing a molecular alignment pattern Φ(x) of a PBP diffraction grating of a reference example.

FIG. 32 is a graph showing a light intensity distribution U(θ) of the PBP diffraction grating of the reference example.

FIG. 33 is a graph showing a molecular alignment pattern Φ(x) of a PBP diffraction grating of Example 3.

FIG. 34 is a graph showing a light intensity distribution U(θ) of the PBP diffraction grating of Example 3.

FIG. 35 includes schematic views illustrating the states of light in the respective PBP diffraction gratings of Example 3 and the reference example.

### DETAILED DESCRIPTION OF THE INVENTION

Hereinafter, embodiments of the present invention are described. The present invention is not limited to the following embodiments. The design may be modified as appropriate within the range satisfying the configuration of the present invention. In the following description, the same components or components having the same function in different drawings are commonly provided with the same reference sign so as to appropriately avoid repetition of description. The configurations of the present invention may appropriately be combined without departing from the spirit of the present invention.

### DEFINITION OF TERMS

### Refractive Indices (nx, ny, nz)

“nx” represents a refractive index in a direction in which the refractive index in the plane is maximum (i.e., slow axis direction). “ny” represents a refractive index in a direction orthogonal to the slow axis in the plane. “nz” represents a refractive index in the thickness direction. A refractive index is a value at 23° C. for light having a wavelength of 550 nm, unless otherwise specified.

### In-Plane Phase Difference (Re)

An in-plane phase difference (Re) is an in-plane phase difference introduced by a layer (film) at 23° C. to light having a wavelength of 550 nm, unless otherwise specified. Re can be determined from the equation Re=(nx−ny)×d, wherein d (nm) represents the thickness of the layer (film). The “phase difference” herein refers to an in-plane phase difference, unless otherwise specified.

The measurement wavelength for optical parameters such as a principal refractive index and a phase difference herein is 550 nm, unless otherwise specified.

Hereinafter, embodiments of the present invention are described. The present invention is not limited to the following embodiments. The design may be modified as appropriate within the range satisfying the configuration of the present invention.

### Embodiment 1

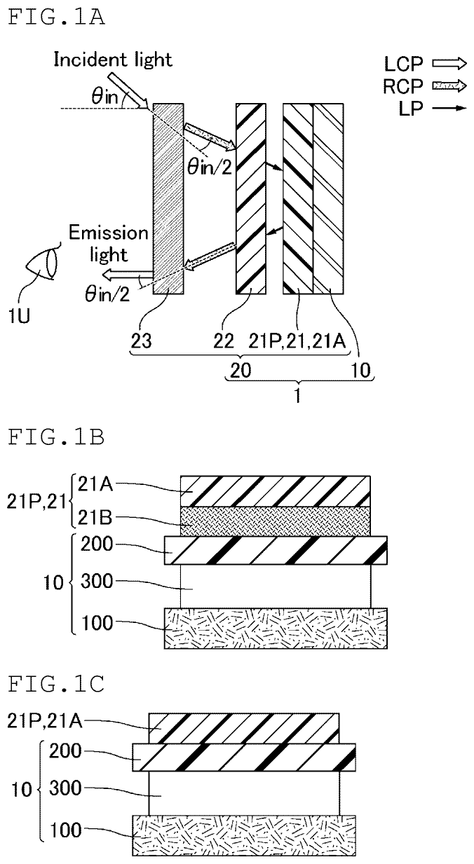

FIG. 1A is a schematic cross-sectional view of a reflective liquid crystal display device of Embodiment 1. FIG. 1B and FIG. 1C are each a schematic cross-sectional view of an example of a polarizer included in the reflective liquid crystal display device of Embodiment 1. As shown in FIG. 1A, a reflective liquid crystal display device 1 of the present embodiment includes a reflective liquid crystal panel 10, and an optical element 20 disposed on or above an observer 1U side of the reflective liquid crystal panel 10 and including a polarizer 21P and a Pancharatnam-Berry phase (PBP) diffraction grating 23.

The reflective liquid crystal display (RLCD) device is a display that uses external light as its light source. A typical reflective liquid crystal display device, for example, uses an electrode having a micro reflective structure (MRS) (hereinafter, such an electrode is referred to also as an MRS electrode) to control the directivity of light in the gaze direction while reducing or preventing interference-induced rainbow formation.

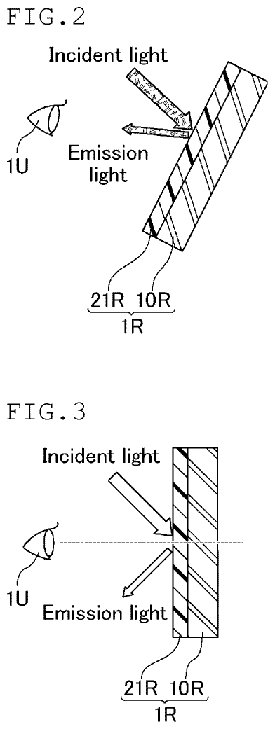

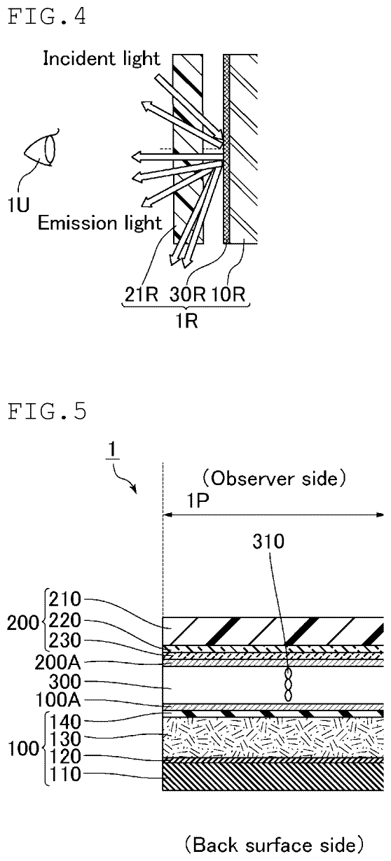

FIG. 2 is a schematic view illustrating a case where a common reflective liquid crystal display device is used for mobile purposes. FIG. 3 is a schematic view illustrating a case where a common reflective liquid crystal display device is used in a wall-mounted configuration, for example. FIG. 4 is a schematic cross-sectional view illustrating a case where a common reflective liquid crystal display device including a diffusion layer is used in a wall-mounted configuration, for example.

As shown in FIG. 2, for mobile purposes, a reflective liquid crystal display device 1R including a reflective liquid crystal panel 10R and a circular polarizer 21R is used in a tilted state while being held in the hand, and thus controlling the direction of emission light to the eye direction is easy.

However, the situation is different when the reflective liquid crystal display device is used in a wall-mounted configuration or when the panel is used in an automobile and faces the driver or passenger. In these cases, as shown in FIG. 3, relative to the normal direction of the display surface of the reflective liquid crystal display device 1R (i.e., front direction of the reflective liquid crystal display device 1R), the incident light enters the reflective liquid crystal display device 1R from an upper 45° oblique direction, and the emission light emerges from the reflective liquid crystal display device in around a lower 45° oblique direction. Thus, in the front direction of the reflective liquid crystal display device 1R which is the eye-position direction (gaze direction) of the viewer (observer 1U), light from the reflective liquid crystal display device 1R is weak.

This is because the reflective liquid crystal display device is held in different states under the same external light conditions, which causes a difference in angle (angle of incidence) of light incident on the display surface of the reflective liquid crystal display device, significantly changing the direction of emission light. Since the directions of emission light controllable using a MRS electrode are limited, the emission light cannot be controlled in the eye-position direction of the viewer in some cases.

Thus, usually, as shown in FIG. 4, a diffusion layer 30R is used to allow the observer 1U to perceive emission light from the reflective liquid crystal display device 1R. However, scattering of light by the diffusion layer 30R is limited, which leaves the issue of light use efficiency.

In order to solve the above issue, the present embodiment uses a PBP diffraction grating 23. The reflective liquid crystal display device 1 of the present embodiment includes, as shown in FIG. 1A, the optical element 20 including the PBP diffraction grating 23 and controlling the directivity of light, the optical element 20 being disposed on or above the observer 1U side of the reflective liquid crystal panel 10. Thus, the reflective liquid crystal display device 1 can control the direction of emission light to the front direction even when the emission light has been derived from incident light with an angle of incidence that would make the direction of emission light other than the front direction in the case where the optical element 20 is not used. This can increase the use efficiency of external light.

The reflective liquid crystal display device disclosed in JP 2006-317599 A includes a reflector having an uneven structure and can cause specular reflection of oblique incident light to the front, but leaves room for improvement in terms of increase in light use efficiency. Also, in the reflective liquid crystal display device disclosed in JP 2006-317599 A, the liquid crystal is aligned on the uneven structure, so that the liquid crystal may be misaligned. There is thus restriction on uneven structures regarding maintaining the liquid crystal alignment.

In contrast, the reflective liquid crystal display device 1 of the present embodiment, as described above, can use the PBP diffraction grating 23 to diffract light and bend oblique incident light to the front. In this manner, the reflective liquid crystal display device 1 of the present embodiment does not necessarily include an uneven structure, thus not involving the issue of liquid crystal misalignment as in JP 2006-317599 A. Hereinbelow, the reflective liquid crystal display device 1 of the present embodiment is described in detail.

As shown in FIG. 1A, the optical element 20 in the present embodiment includes the polarizer 21P and the PBP diffraction grating 23. The optical element 20, in order from its reflective liquid crystal panel 10 side toward its observer 1U side, may include the polarizer 21P, a λ/4 plate 22, and the PBP diffraction grating 23, may include the λ/4 plate 22, the PBP diffraction grating 23, and a circular polarizer 21 as the polarizer 21P, or may include the PBP diffraction grating 23 and the circular polarizer 21 as the polarizer 21P without the λ/4 plate 22 between the reflective liquid crystal panel 10 and the PBP diffraction grating 23. With such an optical element 20, specularly reflected components of oblique incident light are observed by the observer 1U in front of the reflective liquid crystal display device 1, so that the light use efficiency can be increased as compared with the case where a diffusion structure (MRS electrode) is used. Also, liquid crystal misalignment can be reduced or prevented.

In the present embodiment, a case is described where the optical element 20 includes, in order from its reflective liquid crystal panel 10 side toward its observer 1U side, the polarizer 21P, the λ/4 plate 22, and the PBP diffraction grating 23.

In the optical element 20 including, in order from its reflective liquid crystal panel 10 side toward its observer 1U side, the polarizer 21P, the λ/4 plate 22, and the PBP diffraction grating 23, the polarizer 21P is the circular polarizer 21 shown in FIG. 1B or a linear polarizer 21A shown in FIG. 1C. The circular polarizer 21 consists of, as shown in FIG. 1B, the linear polarizer 21A and a λ/4 plate 21B. In the present embodiment, the case is described where the polarizer 21P is the circular polarizer 21 shown in FIG. 1B. Yet, in a case where the polarizer 21P is the linear polarizer 21A, an effect similar to that in the case where the polarizer 21P is the circular polarizer 21 can be achieved.

FIG. 5 is a schematic cross-sectional view of a reflective liquid crystal panel included in the reflective liquid crystal display device of Embodiment 1. As shown in FIG. 5, the reflective liquid crystal panel 10 includes, in order from its back surface side toward its observer 1U side, a first substrate 100, a liquid crystal layer 300, and a second substrate 200. The first substrate 100 is a TFT substrate including thin film transistors (TFTs). The second substrate 200 is a color filter substrate including a color filter layer 220.

The first substrate 100 includes, in order from its back surface side toward its observer 1U side, a supporting substrate 110, a reflective layer 120, an insulating film 130, and a pixel electrode 140. The second substrate 200 includes, in order from its observer 1U side toward its back surface side, a supporting substrate 210, a color filter layer 220, and a common electrode 230. The liquid crystal layer 300 contains liquid crystal molecules 310. In the reflective liquid crystal display device 1, incident light from the observer 1U side is reflected by the reflective layer 120, and the reflected light is transmitted through the liquid crystal layer 300, so that display is provided.

A first alignment film 100A and a second alignment film 200A each having a function of controlling the alignment of the liquid crystal molecules 310 in the liquid crystal layer 300 may respectively be disposed between the first substrate 100 and the liquid crystal layer 300 and between the second substrate 200 and the liquid crystal layer 300. The first alignment film 100A and the second alignment film 200A have, during no voltage application to the liquid crystal layer 300 (when the voltage applied to the liquid crystal layer 300 is lower than the threshold voltage), the functions of aligning the liquid crystal molecules 310 in the liquid crystal layer 300 substantially perpendicular to the main surface of the first substrate 100 and the main surface of the second substrate 200, respectively.

Here, aligning liquid crystal molecules substantially perpendicular to the main surface of a substrate means making the pre-tilt angle of the liquid crystal molecules 85° or greater and 90° or smaller, preferably 88° or greater and 90° or smaller, more preferably 89° or greater and 90° or smaller, to the main surface of the substrate. The pre-tilt angle of liquid crystal molecules means the angle of inclination of the long axes of the liquid crystal molecules from the main surfaces of the substrates during no voltage application to the liquid crystal layer.

The reflective liquid crystal display device 1 includes the circular polarizer 21. This configuration can achieve the following effect. External light transmitted through the circular polarizer 21 and incident on the reflective liquid crystal panel 10 undergoes a phase shift of ¼ of a wavelength, resulting in transformation of linearly polarized light into, for example, right-handed circularly polarized light. Since the initial alignment of the liquid crystal molecules 310 (the alignment direction of the liquid crystal molecules 310 with no voltage applied between the pixel electrode 140 and the common electrode 230) is a vertical alignment, the external light passes through the liquid crystal layer 300 as is and is then reflected by the reflective layer 120, so that the handedness of the polarized light is reversed from the right-handed circularly polarized light to the left-handed circularly polarized light. This makes the external light, having returned to the circular polarizer 21 by traveling in the reverse direction of the incident direction, become linearly polarized light vibrating at an angle orthogonal to the transmission axis of the linear polarizer. Such linearly polarized light cannot pass through the circular polarizer 21, and thus black display can be achieved.

Meanwhile, the following effect can be achieved when voltage is applied between the pixel electrode 140 and the common electrode 230 and the liquid crystal molecules 310 are rotated. External light transmitted through the circular polarizer 21 and incident on the reflective liquid crystal panel 10 undergoes a phase shift of ¼ of a wavelength, resulting in transformation of linearly polarized light into, for example, right-handed circularly polarized light. The external light undergoes an additional phase shift of ¼ of the wavelength through the liquid crystal layer 300, and thus the phase difference is ½ of the wavelength when the external light reaches the reflective layer 120, so that the external light is reflected as linearly polarized light. After the reflection, the external light goes back through the path of incidence, passing through the circular polarizer 21 to achieve white display.

The λ/4 plate 22 is a phase difference layer that introduces an in-plane phase difference of from 107.5 nm to 167.5 nm to light having a wavelength of 550 nm. The phase difference layer has a function of altering the polarization of incident light by using a material such as a birefringent material to introduce a phase shift between two orthogonal polarization components.

The λ/4 plate 22 is made of, for example, a photopolymerizable liquid crystal material. The photopolymerizable liquid crystal material has a skeletal molecular structure terminated with a photopolymerizable group such as an acrylate group or a methacrylate group, for example.

The λ/4 plate 22 can be formed by the following method, for example. First, a photopolymerizable liquid crystal material is dissolved in an organic solvent such as propylene glycol monomethyl ether acetate (PGMEA). Then, the obtained solution is applied to a surface of a base material (for example, polyethylene terephthalate (PET) film) to form a film of the solution. The film of the solution is successively pre-baked, irradiated with light (for example, ultraviolet light), and post-baked, so that the λ/4 plate 22 is formed.

The λ/4 plate 22 also can be a stretched polymer film, for example. The polymer film is made of, for example, a cycloolefin polymer, polycarbonate, polysulfone, polyethersulfone, polyethylene terephthalate, polyethylene, polyvinyl alcohol, norbornene, triacetyl cellulose, or diacetyl cellulose.

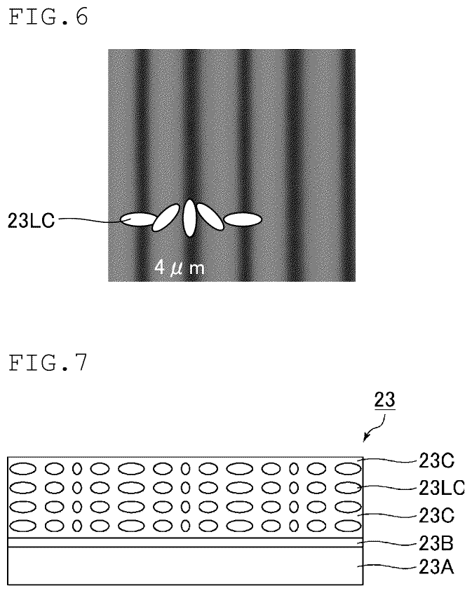

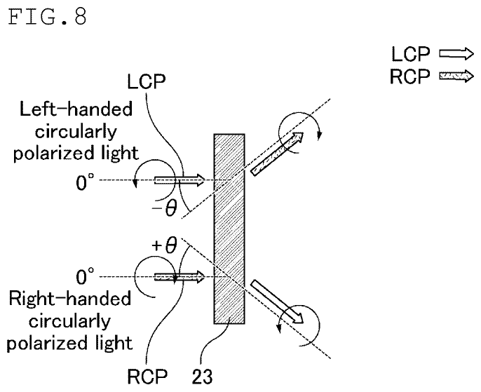

FIG. 6 is a diagram showing the molecular alignment of a polymerizable liquid crystal on a polarizing micrograph of a PBP diffraction grating included in the reflective liquid crystal display device of Embodiment 1. FIG. 7 is a schematic cross-sectional view of the PBP diffraction grating included in the reflective liquid crystal display device of Embodiment 1. FIG. 8 is a schematic view illustrating polarization dependence of the PBP diffraction grating included in the reflective liquid crystal display device of Embodiment 1.

The PBP diffraction grating 23 in the present embodiment includes, as shown in FIG. 6 and FIG. 7, a supporting substrate 23A, an alignment film 23B (for example, photoalignment film), and a phase difference layer 23C containing a cured product of a polymerizable liquid crystal (RM: Reactive mesogen) 23LC in order.

The PBP diffraction grating 23 has a structure in which the slow axis of the cured polymerizable liquid crystal 23LC rotates periodically in the plane. The PBP diffraction grating 23 having an angle of diffraction θ[°], as shown in FIG. 8, diffracts right-handed circularly polarized light RCP incident from the normal direction of the main surface of the PBP diffraction grating 23 in the +θ[°] direction from the normal direction, and diffracts the left-handed circularly polarized light LCP in the −θ direction. In other words, the PBP diffraction grating 23 is a polarization-dependent diffraction element that provides diffraction in a reverse direction depending on the polarized light. The PBP diffraction grating 23 is also referred to as a PBP diffraction element or a PB diffraction grating.

Herein, when the reflective liquid crystal display device is perceived from the normal direction of the display surface of the reflective liquid crystal display device, the normal direction is defined as 0°, an angle upward relative to the normal direction is taken as a positive angle, and an angle downward relative to the normal direction is taken as a negative angle.

The diffraction efficiency η of the PBP diffraction grating 23 is represented by η=sin² (Δndπ/λ) where d represents the thickness of the phase difference layer 23C and Δn represents the birefringence, and the diffraction efficiency is 100% when the phase difference Δnd equals λ/2. Thus, the And of the phase difference layer 23C is typically designed to equal λ/2. Since the PBP diffraction grating 23 functions as a λ/2 plate, incident circularly polarized light emerges as opposite-handed circularly polarized light through conversion.

The principal of the increase in light use efficiency by the reflective liquid crystal display device 1 of the present embodiment is described. As shown in FIG. 1A, when the angle of incidence θin[′] of incident light on the PBP diffraction grating 23 is twice the angle of diffraction θ[°] of the PBP diffraction grating 23, left-handed circularly polarized light LCP, which is one of left-handed circularly polarized light LCP and right-handed circularly polarized light RCP included in the incident light, is diffracted −θin/2[°] (i.e., −θ[°]) by the PBP diffraction grating 23, thus being converted to right-handed circularly polarized light RCP. The light is converted to linearly polarized light LP by the λ/4 plate 22 and then passes through the circular polarizer 21. With voltage applied between the pixel electrode 140 and the common electrode 230, light having been specularly reflected by the reflective liquid crystal panel 10 passes through the circular polarizer 21 as linearly polarized light LP, and is converted to right-handed circularly polarized light RCP by the λ/4 plate 22. The right-handed circularly polarized light RCP is diffracted θin/2 (i.e., θ[°]) by the PBP diffraction grating 23, and light emitted in the front direction of the reflective liquid crystal display device 1 is perceived by the observer 1U. As described above, since the reflective liquid crystal display device 1 of the present embodiment uses the specularly reflected components of light, the light use efficiency can be increased as compared with the case where the diffusion structure as described in JP 2006-317599 A is used.

As described above, the PBP diffraction grating 23 has a characteristic of making incident circularly polarized light emerge as opposite-handed circularly polarized light. In a display device using polarized light as in a liquid crystal display device, use of the PBP diffraction grating 23 can diffract light without decreasing the light use efficiency.

The angle of incidence of incident light on the reflective liquid crystal display device 1 is preferably equal to or more than 1.5 times and equal to or less than 2.5 times the angle of diffraction θ of the PBP diffraction grating 23. This mode can further increase light use efficiency. The angle of incidence of incident light on the reflective liquid crystal display device 1 is more preferably equal to or more than 1.8 times and equal to or less than 2.2 times the angle of diffraction θ of the PBP diffraction grating 23, still more preferably twice the angle of diffraction θ of the PBP diffraction grating 23. Herein, the angle of incidence means the angle of incident light to the normal direction (front direction) of the display surface of the reflective liquid crystal display device, and the angle of emergence means the angle of emission light to the normal direction of the display surface of the reflective liquid crystal display device.

Also, the angle of incidence of incident light on the reflective liquid crystal display device 1 is preferably equal to or more than 0.5 times and equal to or less than 1.5 times the angle of diffraction θ of the PBP diffraction grating 23. This mode can also further increase light use efficiency. The angle of incidence of incident light on the reflective liquid crystal display device 1 is more preferably equal to or more than 0.8 times and equal to or less than 1.2 times the angle of diffraction θ of the PBP diffraction grating 23, still more preferably equal to the angle of diffraction θ of the PBP diffraction grating 23.

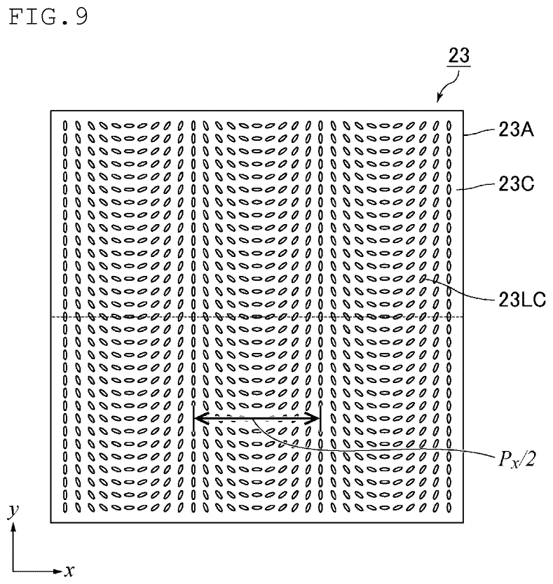

FIG. 9 is a schematic plan view of the PBP diffraction grating included in the reflective liquid crystal display device of Embodiment 1. As shown in FIG. 9, the PBP diffraction grating 23 is an optical film including a phase difference layer 23C obtained by ultraviolet-curing a polymerizable liquid crystal named polymerizable liquid crystal 23LC.

The PBP diffraction grating 23 includes the supporting substrate 23A and the phase difference layer 23C disposed on the supporting substrate 23A and contains the cured polymerizable liquid crystal 23LC. The alignment film 23B may be disposed between the supporting substrate 23A and the phase difference layer 23C. In the PBP diffraction grating 23, the cured polymerizable liquid crystal 23LC is periodically aligned in the plane of the phase difference layer 23C, which causes diffraction with which the PBP diffraction grating 23 can exhibit the lens function. The PBP diffraction grating 23 can be designed to provide a different angle of diffraction by changing the pitch of the polymerizable liquid crystal 23LC.

As shown in FIG. 9, the slow axis (optical axis) of the polymerizable liquid crystal 23LC, in the plane of the phase difference layer 23C, rotates periodically in an x-axis direction from a first end to a second end of the phase difference layer 23C and does not rotate periodically in a y-axis direction orthogonal to the x-axis direction. The x-axis direction corresponds to the left-right direction (horizontal direction) of the reflective liquid crystal panel 10.

As shown in FIG. 9, in a plan view, the slow axis of the cured polymerizable liquid crystal 23LC rotates periodically in the plane of the phase difference layer 23C. Specifically, in a plan view, the orientation of the slow axis of the cured polymerizable liquid crystal 23LC varies while rotating in the x-axis direction from the first end to the second end of the phase difference layer 23C. In other words, the phase difference layer 23C in the PBP diffraction grating 23 has a liquid crystal alignment pattern in which the orientation of the optical axis derived from the cured polymerizable liquid crystal 23LC varies while rotating continuously in the in-plane x-axis direction. In a plan view, the slow axis of the cured polymerizable liquid crystal 23LC in the present embodiment rotates periodically in the x-axis direction and does not rotate periodically in the y-axis direction orthogonal to the x-axis direction. The long axis of the cured polymerizable liquid crystal 23LC corresponds to the slow axis. The orientation of the slow axis can be verified using a polarizing microscope or Axoscan (Axometrics, Inc.).

The PBP diffraction grating 23 can be produced, for example, by the methods disclosed in WO 2019/189818 and JP 2008-532085 T, for example.

The PBP diffraction grating 23 preferably includes the phase difference layer 23C which introduces a phase difference Δnd satisfying the following Formula 1 or Formula 2 to lights having wavelengths λ of 450 nm, 550 nm, and 650 nm. This mode can further increase light use efficiency.

$${sin}^{4} ( \frac{Δ nd π}{λ} ) > \frac{1}{4 π} \qquad ( Formula 1 )$$

$${sin}^{2} ( \frac{Δ nd π}{λ} ) {cos}^{2} ( \frac{Δ nd π}{λ} ) > \frac{1}{4 π} \qquad ( Formula 2 )$$

The phase difference Δnd can be measured with “AxoScan FAA-3 series” available from Axometrics, Inc.

### Embodiment 2

The features unique to the present embodiment are mainly described here, and description of the matters already described in Embodiment 1 is omitted. The present embodiment is substantially the same as Embodiment 1, except that the arrangement of the components in the optical element 20 is different.

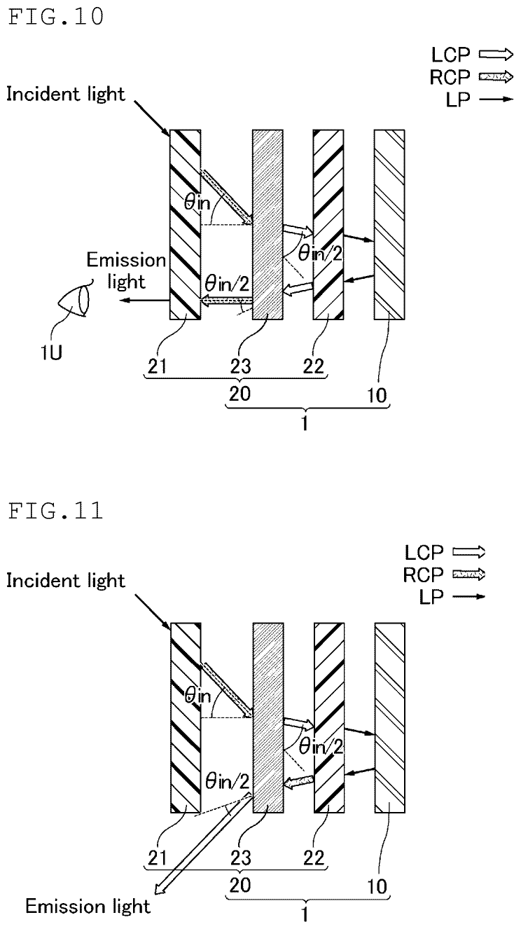

FIG. 10 is a schematic cross-sectional view showing the white display state of a reflective liquid crystal display device of Embodiment 2. FIG. 11 is a schematic cross-sectional view showing the black display state of the reflective liquid crystal display device of Embodiment 2. As shown in FIG. 10 and FIG. 11, the optical element 20 in the present embodiment includes, in order from its reflective liquid crystal panel 10 side toward its observer 1U side, the λ/4 plate 22, the PBP diffraction grating 23, and the circular polarizer 21 as the polarizer 21P. This mode also can increase light use efficiency as in Embodiment 1.

FIG. 10 assumes the case of white display, and the reflective liquid crystal panel 10 has a function similar to that of a mirror. During white display shown in FIG. 10, specularly reflected components enter the human eye as in Embodiment 1. During black display shown in FIG. 11, the reflective liquid crystal panel 10 has a function of “λ/4 plate+mirror”. Thus, light incident on the reflective liquid crystal panel 10 is reflected by the reflective liquid crystal panel 10, passes through the λ/4 plate 22 to be right-handed circularly polarized light RCP, which is a polarization state different from that during white display. The direction of diffraction provided by the PBP diffraction grating 23 is thus opposite to that during white display, so that emission light does not enter the observer 1U's eye. This means that the screen appears bright during white display and appears dark during black display, so that the contrast ratio increases.

### Embodiment 3

The features unique to the present embodiment are mainly described here, and description of the matters already described in Embodiment 1 is omitted. The present embodiment is substantially the same as Embodiments 1 and 2, except that the arrangement of the components in the optical element 20 is different.

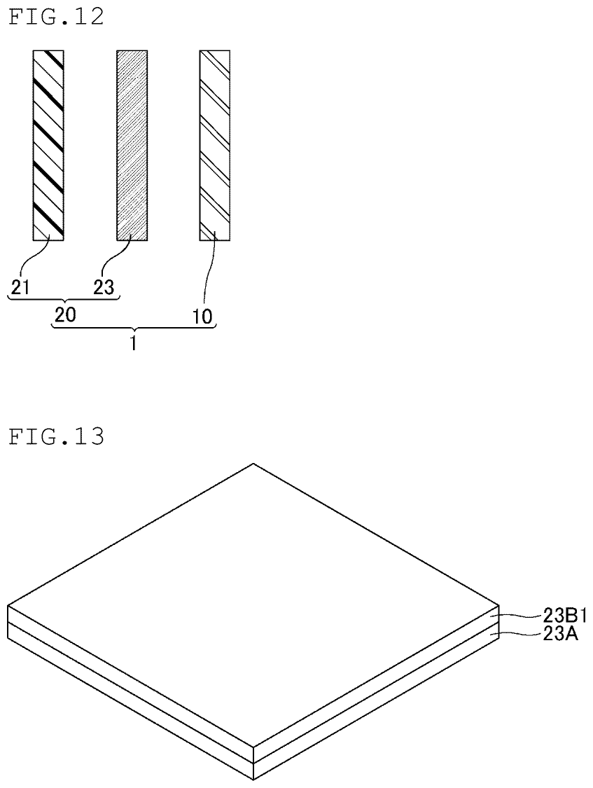

FIG. 12 is a schematic cross-sectional view of a reflective liquid crystal display device of Embodiment 3. As shown in FIG. 12, the optical element 20 in the present embodiment includes, in order from its reflective liquid crystal panel 10 side toward its observer 1U side, the PBP diffraction grating 23 and the circular polarizer 21 as the polarizer 21P, and does not include the λ/4 plate between the reflective liquid crystal panel 10 and the PBP diffraction grating 23. This mode also can increase light use efficiency as in Embodiment 1.

In the reflective liquid crystal display device 1 of the present embodiment, the λ/4 plate 22 disposed between the PBP diffraction grating 23 and the reflective liquid crystal panel 10 in Embodiments 1 and 2 is unnecessary. The reflective liquid crystal panel 10 of the present embodiment functions as “λ/4 plate+mirror” during white display and as a mirror during black display.

The following Modified Examples 1 to 3 describe three modes of reducing or preventing color breakup on the reflective liquid crystal display device 1 of Embodiments 1 to 3.

### Modified Example 1 of Embodiments 1 to 3

Preferably, the PBP diffraction grating 23 in the reflective liquid crystal display device 1 of the present modified example as the first mode of reducing or preventing color breakup includes the phase difference layer 23C containing a cured product of the polymerizable liquid crystal 23LC, the slow axis of the polymerizable liquid crystal 23LC rotates periodically in the x-axis direction from the first end to the second end of the phase difference layer 23C in the plane of the phase difference layer 23C, and the molecular alignment pattern Φ(x) [°] as the alignment direction of the polymerizable liquid crystal 23LC at a position a distance x [μm] away in the x-axis direction from a position where the slow axis of the polymerizable liquid crystal 23LC is parallel to the x-axis direction satisfies the following Formula 3. This mode can reduce or prevent color breakup on the reflective liquid crystal display device 1.

$$∅ ( x ) = \frac{180 °}{Λ} x + m sin ( nx + A ) \qquad ( Formula 3 )$$

In Formula 3, A represents the pitch [μm] at which the slow axis of the polymerizable liquid crystal rotates 180° in the plane of the phase difference layer, and m, n, and A are each an arbitrary constant.

The closer the m and n in Formula 3 are to 0, the greater the effect of increasing the luminance, but the higher the possibility of occurrence of color breakup. The higher the absolute values of the m and n are, the smaller the effect of increasing the luminance, but the more the color breakup can be reduced or prevented.

A in Formula 3 is, for example, 0.

Any position in the x-axis direction on the PBP diffraction grating 23 can be set as the x=0 position (position where the molecular alignment is at) 0°.

The PBP diffraction grating 23 in the present modified example can be produced, for example, as described below.

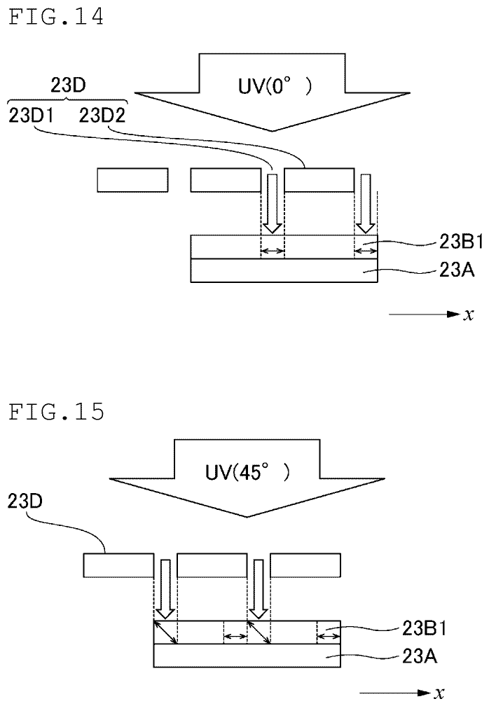

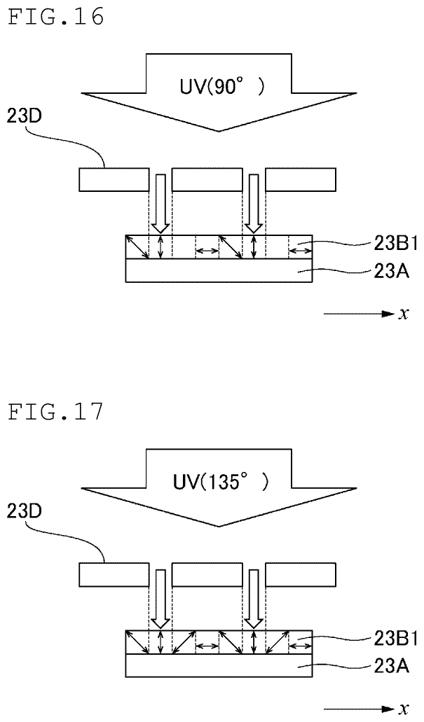

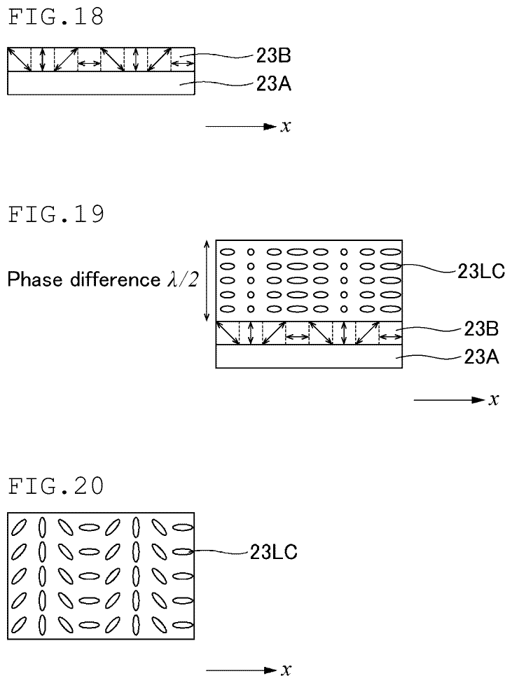

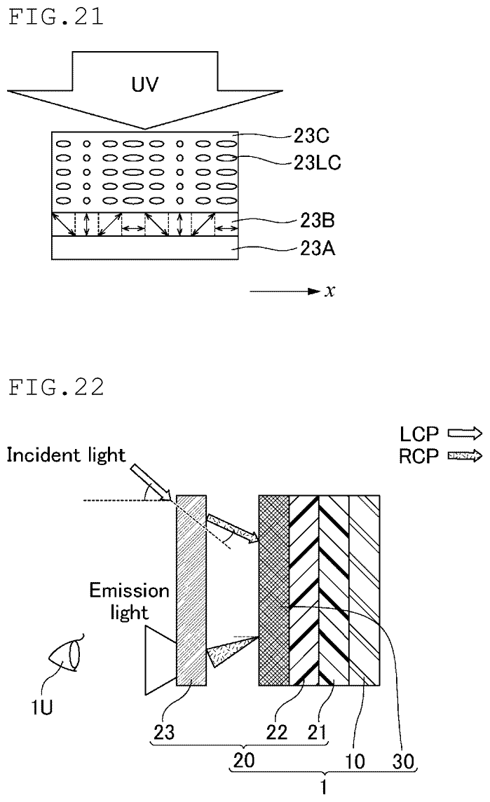

FIG. 13 is a schematic view showing a step of forming a coating to serve as an alignment film in a method for producing a PBP diffraction grating in a reflective liquid crystal display device of Modified Example 1 of Embodiments 1 to 3. FIG. 14 is a schematic view showing a first photoirradiation step in the method for producing the PBP diffraction grating in the reflective liquid crystal display device of Modified Example 1 of Embodiments 1 to 3. FIG. 15 is a schematic view showing a second photoirradiation step in the method for producing the PBP diffraction grating in the reflective liquid crystal display device of Modified Example 1 of Embodiments 1 to 3. FIG. 16 is a schematic view showing a third photoirradiation step in the method for producing the PBP diffraction grating in the reflective liquid crystal display device of Modified Example 1 of Embodiments 1 to 3. FIG. 17 is a schematic view showing a fourth photoirradiation step in the method for producing the PBP diffraction grating in the reflective liquid crystal display device of Modified Example 1 of Embodiments 1 to 3. FIG. 18 is a schematic view showing a baking step in the method for producing the PBP diffraction grating in the reflective liquid crystal display device of Modified Example 1 of Embodiments 1 to 3. FIG. 19 and FIG. 20 are each a schematic view showing a step of forming a film of a polymerizable liquid crystal in the method for producing the PBP diffraction grating in the reflective liquid crystal display device of Modified Example 1 of Embodiments 1 to 3. FIG. 21 is a schematic view showing a step of curing the polymerizable liquid crystal in the method for producing the PBP diffraction grating in the reflective liquid crystal display device of Modified Example 1 of Embodiments 1 to 3. The double-headed arrows in FIG. 14 to FIG. 19 and FIG. 21 each indicate an alignment controlling direction.

The method for producing the PBP diffraction grating 23 in the present modified example includes the step of forming a coating to serve as an alignment film shown in FIG. 13, the first photoirradiation step shown in FIG. 14, the second photoirradiation step shown in FIG. 15, the third photoirradiation step shown in FIG. 16, the fourth photoirradiation step shown in FIG. 17, the baking step shown in FIG. 18, the step of forming a film of a polymerizable liquid crystal shown in FIG. 19 and FIG. 20, and the step of curing the polymerizable liquid crystal shown in FIG. 21. These steps are specifically described below.

First, in the step of forming a coating to serve as an alignment film shown in FIG. 13, an alignment film material containing a photoisomerizable polymer is applied to the supporting substrate 23A (for example, glass substrate) to form a coating to serve as an alignment film 23B1. The alignment film material can be applied by, for example, spin coating, and the rotational speed can be set at, for example, 1000 rpm. The photoisomerizable polymer is a polymer that has a photoisomerizable functional group. Examples of photoisomerizable functional groups include an azobenzene group.

Next, in the first photoirradiation step shown in FIG. 14, through a binary mask 23D having apertures 23D1 (for example, width 2 μm) and blocked portions 23D2 (for example, width 6 μm) are arranged periodically in the x-axis direction, linearly polarized light (for example, ultraviolet light having a wavelength of 365 nm) polarized in the first direction (for example, 0° direction) is applied, for example, with 100 mJ/cm².

Then, in the second photoirradiation step shown in FIG. 15, the binary mask 23D is shifted 2 μm in the periodic direction (x-axis direction), and linearly polarized light (for example, ultraviolet light having a wavelength of 365 nm) polarized in a second direction (for example, 45° direction) different from the first direction is applied with the same energy as in the first photoirradiation step.

Subsequently, in the third photoirradiation step shown in FIG. 16, the binary mask 23D is shifted 2 μm in the periodic direction (x-axis direction) to apply linearly polarized light (for example, ultraviolet light having a wavelength of 365 nm) polarized in a third direction (for example, 90° direction) different from the first and second directions with the same energy as in the first and second photoirradiation steps.

Next, in the fourth photoirradiation step shown in FIG. 17, the binary mask 23D is shifted 2 μm in the periodic direction (x-axis direction) to apply linearly polarized light (for example, ultraviolet light having a wavelength of 365 nm) polarized in a fourth direction (for example, 135° direction) different from the first, second, and third directions with the same energy as in the first, second, and third photoirradiation steps.

Then, in the baking step shown in FIG. 18, for example, the workpiece is baked at 160° C. for 20 minutes to form the alignment film 23B on the supporting substrate 23A.

Subsequently, in the step of forming a film of a polymerizable liquid crystal shown in FIG. 19 and FIG. 20, the polymerizable liquid crystal 23LC is applied to the alignment film 23B. In order to make the phase difference Δnd of the phase difference layer 23C be λ/2, the polymerizable liquid crystal 23LC can be applied, for example, by spin coating at a spin speed of 1000 rpm.

Then, in the step of curing the polymerizable liquid crystal shown in FIG. 21, the polymerizable liquid crystal 23LC is irradiated with light to be cured into the phase difference layer 23C. The polymerizable liquid crystal 23LC, for example, can be cured by applying ultraviolet light (wavelength 365 nm) with 200 mJ/cm². In this manner, the PBP diffraction grating 23 including the supporting substrate 23A, the alignment film 23B, and the phase difference layer 23C in this order can be obtained.

### Modified Example 2 of Embodiments 1 to 3

FIG. 22 is a schematic cross-sectional view of a reflective liquid crystal display device of Modified Example 2 of Embodiments 1 to 3. The reflective liquid crystal display device 1 of the present modified example as the second mode of reducing or preventing color breakup preferably further includes, as shown in FIG. 22, the diffusion layer 30 in the observer 1U side of the optical element 20 or between components constituting the optical element 20. This mode causes the specularly reflected components of emission light to spread to a certain degree to make red light R, green light G, and blue light B overlap, thus reducing or preventing color breakup due to wavelength dependence of the angle of diffraction. For example, red light R is light having a wavelength of 650 nm, green light G is light having a wavelength of 550 nm, and blue light B is light having a wavelength of 450 nm.

The diffusion layer 30 has a light diffusive property. Examples of the diffusion layer 30 include adhesive layers containing several micrometer-sized particles. For example, in FIG. 1A, attaching the reflective liquid crystal panel 10 and the circular polarizer 21 to each other using an adhesive layer containing several micrometer-sized particles enables the adhesive layer to serve as the diffusion layer 30 disposed between the reflective liquid crystal panel 10 and the circular polarizer 21. Also, as shown in FIG. 22, attaching the λ/4 plate 22 and the PBP diffraction grating 23 to each other using an adhesive layer containing several micrometer-sized particles enables the adhesive layer to serve as the diffusion layer 30 disposed between the λ/4 plate 22 and the PBP diffraction grating 23.

### Modified Example 3 of Embodiments 1 to 3

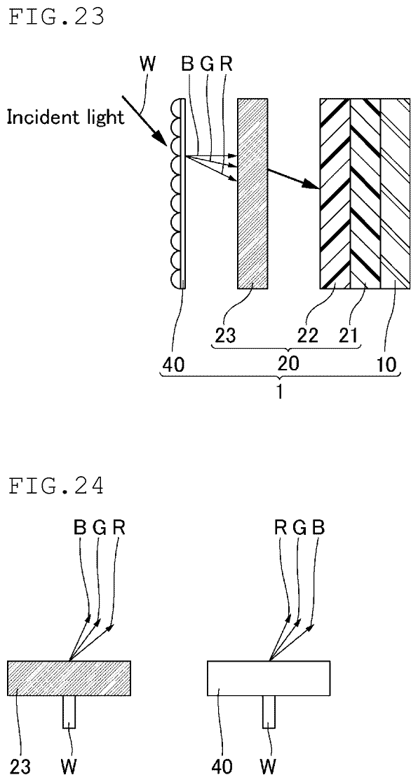

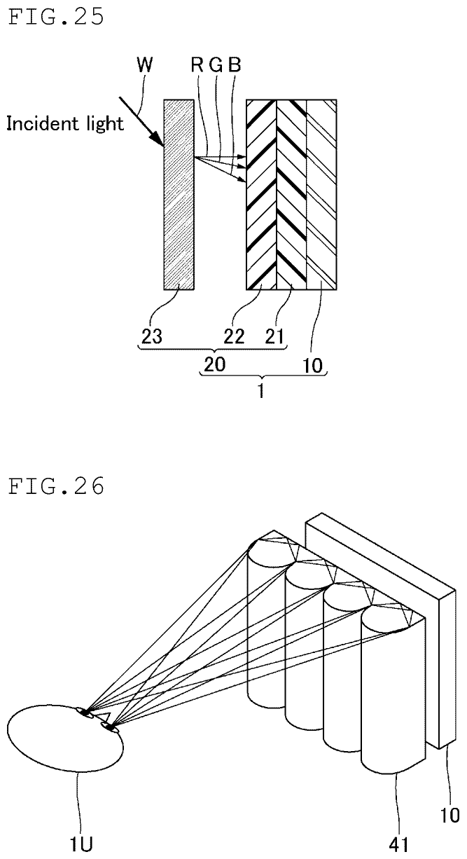

FIG. 23 is a schematic cross-sectional view illustrating the state of light in a reflective liquid crystal display device of Modified Example 3 of Embodiments 1 to 3. FIG. 24 includes schematic views illustrating the difference between a diffractive element and a refractive element. FIG. 25 is a schematic cross-sectional view illustrating the state of light in the reflective liquid crystal display device of Embodiment 1. FIG. 23 to FIG. 25 show the state of light when white light W is incident on the device.

The reflective liquid crystal display device 1 of the present modified example as the third mode of reducing or preventing color breakup preferably further includes, as shown in FIG. 23, a refractive element 40 in the observer 1U side of the optical element 20. As shown in FIG. 24, the PBP diffraction grating 23, which is a diffractive element, more greatly bends light having a longer wavelength, while the refractive element 40 more greatly bends light having a shorter wavelength. Thus, as shown in FIG. 25, the reflective liquid crystal display device 1 of Embodiment 1 including the PBP diffraction grating 23 but no refractive element 40 may possibly cause color breakup. However, as shown in FIG. 23, the reflective liquid crystal display device 1 of the present modified example including both the PBP diffraction grating 23 and the refractive element 40 causes light components having undergone color splitting through the refractive element 40 to overlap again through the PBP diffraction grating 23, thus reducing or preventing color breakup.

FIG. 26 is a schematic perspective view of a lenticular lens. The refractive element 40 is, for example, a lenticular lens. As shown in FIG. 26, the lenticular lens 41 includes, on its observer 1U side surface, multiple convex cylindrical lenses which are convex toward the observer 1. The refractive element 40 is disposed, for example, on the side in the reflective liquid crystal display device 1 closest to the observer 1U.

### EXAMPLES

The effect of the present invention is described below based on examples, a comparative example, and a reference example. The present invention is not limited to these examples.

### Example 1

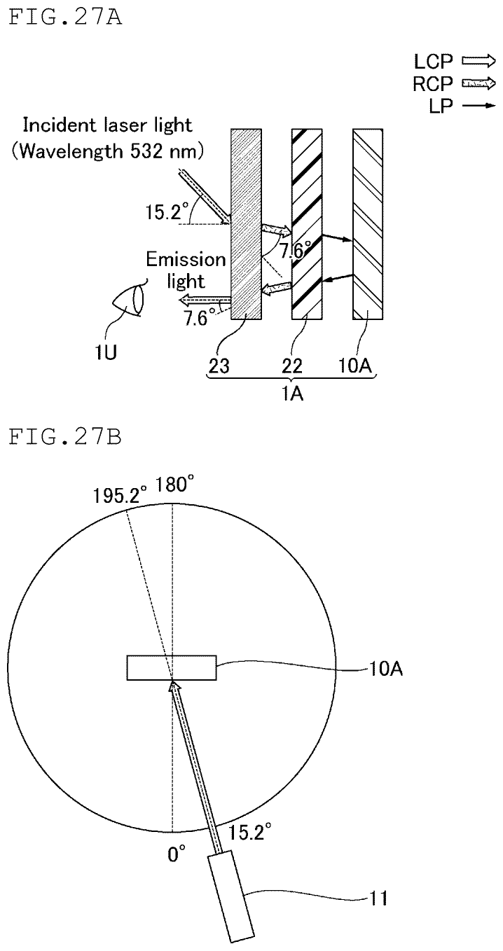

FIG. 27A is a schematic cross-sectional view of a verification device of Example 1. In order to verify the principle of the reflective liquid crystal display device 1 of Embodiment 1, a verification device 1A of Example 1 shown in FIG. 27A was produced. The verification device 1A of Example 1 had a configuration similar to that of the reflective liquid crystal display device 1 of Embodiment 1, except for including a mirror 10A in place of the reflective liquid crystal panel 10 and the circular polarizer 21. The mirror 10A has a function equivalent to that of the optical component consisting of the reflective liquid crystal panel 10 and the circular polarizer 21. Thus, the principle of the reflective liquid crystal display device 1 of Embodiment 1 can be verified using the verification device 1A.

In the principal verification experiment in Example 1, laser light having a wavelength of 532 nm was used as incident light to measure whether diffraction of the principal can be achieved when the reflective liquid crystal panel 10 and the circular polarizer 21 were replaced with the mirror 10A.

In the verification device 1A of Example 1, the PBP diffraction grating 23 was used in which the distance (pitch Λ [μm]) over which the slow axis of the polymerizable liquid crystal 23LC rotates 180° in the plane was 4 μm as shown in FIG. 6. The angle of diffraction θ provided by the PBP diffraction grating 23 is represented by θ=arcsin (λ/Λ). In the present example, θ=7.6°. The λ/4 plate 22 was a phase difference film containing a cycloolefin polymer (COP).

The angle of emergence of emission light when the angle of incidence of incident light was 15.2° was measured. Theoretically, emission light is emitted at 0°, and the experiment result was also 0°. This verified the principal of Embodiment 1. The angle of incidence and the angle of emergence were measured as follows. As shown in FIG. 27B, the mirror 10A was disposed in the center of a large-area rotating breadboard (Thorlabs, Inc.) such that the straight line connecting 0° and 180° of the board scale would be the normal. Laser light was incident on the mirror from the 15.2° direction such that the laser light emitted from the light source 11 would pass 15.2° and 195.2° of the board scale, so that the angle of incidence was determined. The angle of emergence was measured by reading the board scale at the position where the reflected light passed. FIG. 27B is a schematic view showing a method for measuring an angle of incidence and an angle of emergence using a large-area rotating breadboard.

### Example 2 and Comparative Example

In the present example and comparative example, the reflective liquid crystal display device 1 of Embodiment 1 is used to examine the range of phase differences of the phase difference layer 23C in the PBP diffraction grating 23 (i.e., phase differences of the PBP diffraction grating 23) within which a better effect of increasing light use efficiency can be achieved. In Example 2, the reflective liquid crystal display device 1 of Embodiment 1 is used. In the comparative example, a common reflective liquid crystal display device 1R including the diffusion layer 30R shown in FIG. 4 is used.

When the reflective liquid crystal display device 1R of the comparative example is used, light reflected by the reflective liquid crystal panel 10R and equally scattered at all the azimuthal angles leads to a light intensity per unit solid angle of (incident light intensity)×1/(4π) as shown by the following Formula A. A light intensity higher than this value is regarded as achieving the effect of increasing light use efficiency.

$$( Light intensity per unit solid angle ) = ( Incident light intensity ) \times 1 / ( 4 π ) \qquad ( Formula A )$$

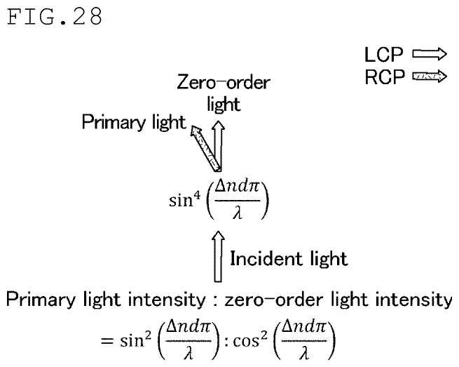

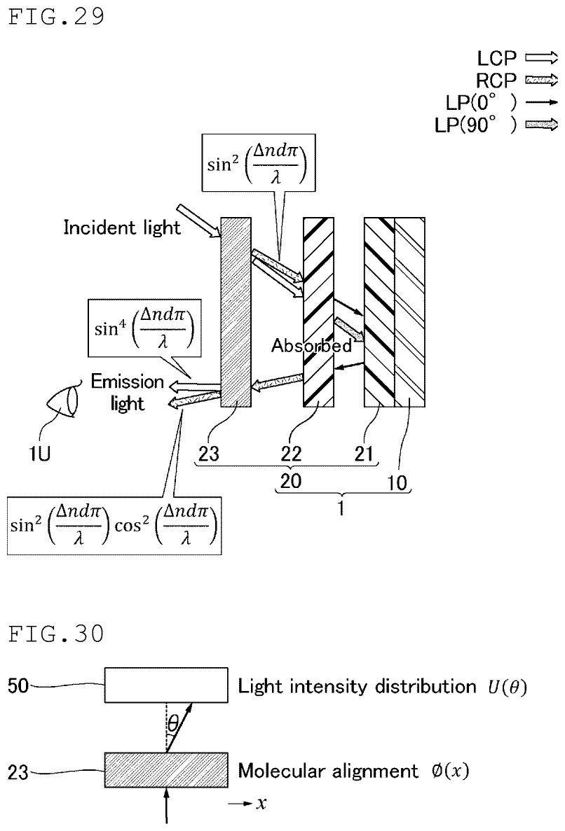

FIG. 28 is a diagram illustrating generation of zero-order light. FIG. 29 is a schematic cross-sectional view illustrating the state of light in a reflective liquid crystal display device of Example 2. A phase difference Δnd other than λ/2 introduced by the PBP diffraction grating 23, as shown in FIG. 28, generates zero-order light which is not diffracted as well as primary light which is diffracted. The ratio of these light intensities, i.e., (primary light intensity):(zero-order light intensity) equals sin² (Δndπ/λ):cos² (Δndπ/λ). Also, the handedness of the primary circularly polarized light and the handedness of the zero-order circularly polarized light are opposite. For example, when the incident light is left-handed circularly polarized light LCP, the primary light is right-handed circularly polarized light RCP, and the zero-order light is left-handed circularly polarized light LCP.

The light intensity of emission light when zero-order light is generated in the reflective liquid crystal display device 1 of the present example is as shown in FIG. 29. Here, the incident light is left-handed circularly polarized light LCP and the light intensity is 1. Passing through the PBP diffraction grating 23, the incident light is split into zero-order light (left-handed circularly polarized light LCP) and primary light (right-handed circularly polarized light RCP). The primary light intensity is sin² (Δndπ/λ). Passing through the λ/4 plate 22, both the zero-order light and the primary light become linearly polarized lights LP with their planes of vibration being orthogonal. Thus, the circular polarizer 21 designed to transmit primary light (right-handed circularly polarized light RCP) absorbs zero-order light. As a result, only primary light is reflected by the reflective liquid crystal panel 10, emitted from the circular polarizer 21, and converted back to circularly polarized light through the λ/4 plate 22. The polarization state here is right-handed circularly polarized light RCP. The light, when passing through the PBP diffraction grating 23 again, is split into zero-order light (right-handed circularly polarized light RCP) and primary light (left-handed circularly polarized light LCP).

FIG. 29 shows that primary light (left-handed circularly polarized light LCP) enters the eye. Yet, zero-order light may enter the eye in some cases where, for example, the equation “(angle of diffraction of PBP diffraction grating)=(angle of incidence of incident light)” holds. Thus, only the zero-order light intensity or the primary light intensity needs to be above the light intensity 1/(4π) per unit solid angle of the reflective liquid crystal display device 1R of the comparative example. In other words, the phase difference Δnd introduced by the phase difference layer 23C in the PBP diffraction grating 23 to lights having wavelengths λ of 450 nm, 550 nm, and 650 nm needs to satisfy the above Formula 1 or Formula 2.

### Example 3 and Reference Example

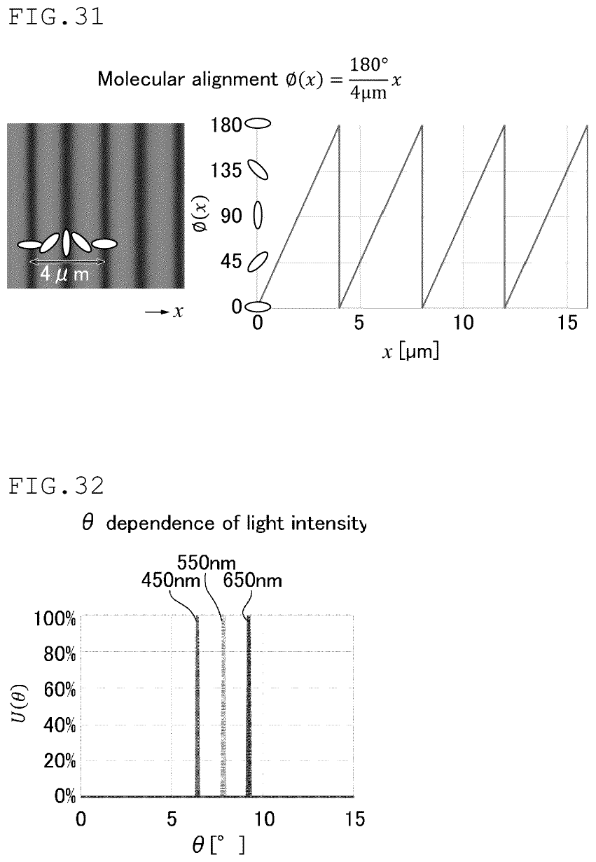

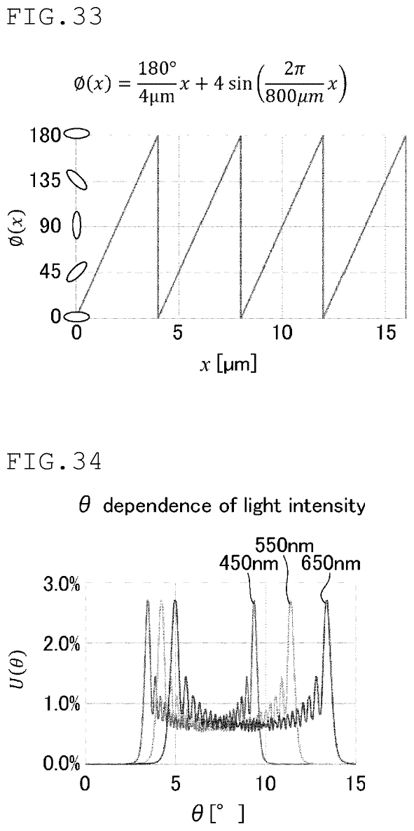

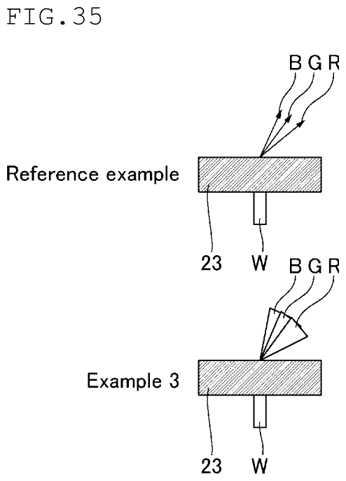

In Example 3 and a reference example, the configurations that further increase light use efficiency were examined. FIG. 30 is a schematic view illustrating an angle of diffraction θ of a PBP diffraction grating and light intensity distribution U (θ) on a screen. FIG. 31 is a graph showing a molecular alignment pattern Φ(x) of a PBP diffraction grating of a reference example. FIG. 32 is a graph showing a light intensity distribution U(θ) of the PBP diffraction grating of the reference example. FIG. 33 is a graph showing a molecular alignment pattern Φ(x) of a PBP diffraction grating of Example 3; the molecular alignment pattern Φ(x) is also referred to as a molecular alignment Φ(x). FIG. 34 is a graph showing a light intensity distribution U(θ) of the PBP diffraction grating of Example 3. FIG. 35 includes schematic views illustrating the states of light in the respective PBP diffraction gratings of Example 3 and the reference example.

The angle of diffraction of the PBP diffraction grating is wavelength dependent. The angle of diffraction can be calculated using, for example, the Fraunhofer diffraction. A case is considered where in a plan view, a molecular alignment pattern of the polymerizable liquid crystal at a position a distance x [μm] away in the x-axis direction from a position where the slow axis of the polymerizable liquid crystal 23LC is parallel to the x-axis direction is represented by Φ(x) [°]. Here, when light from the PBP diffraction grating 23 with an angle of diffraction of θ[°] enters the screen 50 as shown in FIG. 30, the light intensity distribution U(θ) on the screen 50 is as shown by the following Formula 4.

$$U ( θ ) = k {\vert {\int }_{- ∞}^{∞} dx {e}^{i \frac{∅ ( x )}{90}} {e}^{- i 2 π ( \frac{tan θ}{λ} ) x} \vert}^{2} \qquad ( Formula 4 )$$

In the formula, θ represents the angle of diffraction of the PBP diffraction grating, λ represents the wavelength of light, and k represents the constant of proportionality. In the present example and reference example, the value of k is set such that the integrated value of U(θ) within the range of θ=−π to π is 100%. The U(θ) in this case is also called diffraction efficiency.

The PBP diffraction grating of the reference example having a molecular alignment pattern satisfying “Φ(x)=x×180°/4 μm” as shown in FIG. 31 was used to calculate the light intensity distributions U(θ) of incident lights having wavelengths of 450 nm, 550 nm, and 650 nm were calculated. This corresponds to calculation when the pitch is 4 μm.

FIG. 32 shows the results. For example, in the case of incident light having a wavelength of 550 nm, the U(θ) was 100% when θ=8°. This indicates that all incident lights bend in the direction where θ=8°, which can be easily verified by experiment. The issue in the reference example is that the angles of diffraction provided to red light R, green light G, and blue light B differ from one another. This causes color breakup and other phenomena that deteriorate the display quality.

Thus, in the present example, the U(θ) was calculated assuming that the molecular alignment satisfies the equation: Φ(x)=kx+m×sin(nx+A). Specifically, Formula 3, where k=180°/Λ in the equation: Φ(x)=kx+m×sin(nx+A), was used. More specifically, as shown in FIG. 33, the U(θ) was calculated assuming that Λ=4 μm (i.e., k=180°/4 μm), η=2π/800 μm, and A=0. This is a calculation used in the theory of frequency modulation (FM) and is known to result in multiple peaks. The results of calculation in FIG. 34 indeed show that the wavelengths each have split peaks and their patterns overlap one another. Thus, as shown in FIG. 35, the PBP diffraction grating 23 of Example 3 satisfying Formula 3 can solve the color breakup issue better than the PBP diffraction grating 23 of the reference example does. FIG. 31 and FIG. 33 appear similar to each other because the second term on the right hand side of Formula 3 is minute, but these are different graphs.

### Example 4

A reflective liquid crystal display device 1 of the present example corresponds to the reflective liquid crystal display device 1 of Modified Example 2 of Embodiments 1 to 3 and has the configuration shown in FIG. 22. The reflective liquid crystal display device 1 of the present example can reduce or prevent color breakup as in Example 3. The reflective liquid crystal display device 1 of Example 3 uses the PBP diffraction grating 23 with a molecular alignment pattern Φ(x) satisfying Formula 3 to reduce or prevent color breakup due to the wavelength dependence of the angle of diffraction. In contrast, the reflective liquid crystal display device 1 of the present example uses the diffusion layer 30 to reduce or prevent color breakup due to the wavelength dependence of the angle of diffraction.

The reflective liquid crystal display device 1 of the present example includes, as shown in FIG. 22, the diffusion layer 30 between the PBP diffraction grating 23 and the λ/4 plate 22. This mode causes the specularly reflected components of emission light to spread to a certain degree to make RGB lights overlap, thus reducing or preventing color breakup.

### Example 5

A reflective liquid crystal display device 1 of the present example corresponds to the reflective liquid crystal display device 1 of Modified Example 3 of Embodiments 1 to 3 and has the configuration shown in FIG. 23. The reflective liquid crystal display device 1 of the present example can reduce or prevent color breakup as in Examples 3 and 4. In the present example, instead of adjusting the molecular alignment pattern of the PBP diffraction grating 23 as in Example 3 or providing the diffusion layer 30 as in Example 4, a refractive element 40 (for example, lenticular lens) is used. As shown in FIG. 25, a reflective liquid crystal display device 1 may possibly cause color breakup when including only the PBP diffraction grating 23 without the refractive element 40. However, the reflective liquid crystal display device 1 of the present example includes, as shown in FIG. 23, the refractive element 40 and the PBP diffraction grating 23 in combination and thus makes the components of light having undergone color splitting through the refractive element 40 overlap again through the PBP diffraction grating 23, thus reducing or preventing color breakup.

### Example 6

A reflective liquid crystal display device 1 of the present example corresponds to the reflective liquid crystal display device 1 of Embodiment 2. The reflective liquid crystal display device 1 of the present example also can increase light use efficiency. In addition, the device can increase the contrast ratio.

### Example 7

A reflective liquid crystal display device 1 of the present example corresponds to the reflective liquid crystal display device 1 of Embodiment 3. The reflective liquid crystal display device 1 of the present example also can increase light use efficiency.

Hereinabove, the embodiments and their modified examples of the present disclosure were described. The present disclosure is not limited to the embodiments and their modified examples, and can be implemented in various forms and their modified examples without departing from the spirit of the present disclosure. Furthermore, the components disclosed in the above-described embodiments and their modified examples can be modified as appropriate. For example, some of the components shown in one embodiment or its modified example may be added to the components of another embodiment or its modified example, or some of the components shown in one embodiment or its modified example may be deleted from the embodiment or its modified example.

In addition, the drawings mainly show each component schematically to facilitate understanding of the invention, and the thickness, length, number, spacing, and the like of each component shown in the drawings may differ from the actual ones due to the convenience of creation of drawings. Furthermore, the configurations of the components shown in the above embodiments are merely examples and are not limited, and it is obvious that various modifications are possible without substantially departing from the effects of the present disclosure.

### REFERENCE SIGNS LIST

1, 1R: reflective liquid crystal display device
1A: verification device
1U: observer
10, 10R: reflective liquid crystal panel
10A: mirror
11: light source
20: optical element
21, 21R: circular polarizer
21A: linear polarizer
21B, 22: λ/4 plate
21P: polarizer
23: Pancharatnam-Berry phase (PBP) diffraction grating
23A: supporting substrate
23B: alignment film
23B1: coating to serve as alignment film
23C: phase difference layer
23D: binary mask
23D1: aperture
23D2: blocked portion
23LC: polymerizable liquid crystal
30, 30R: diffusion layer
40: refractive element
41: lenticular lens
50: screen
100: first substrate
110, 210: supporting substrate
120: reflective layer
130: insulating film
140: pixel electrode
100A: first alignment film
200: second substrate
200A: second alignment film
220: color filter layer
230: common electrode
300: liquid crystal layer
310: liquid crystal molecule
B: blue light
G: green light
LCP: left-handed circularly polarized light
LP: linearly polarized light
R: red light
RCP: right-handed circularly polarized light
W: white light

What is claimed is:

1. A reflective liquid crystal display device comprising:
a reflective liquid crystal panel; and
an optical element disposed on or above an observer side of the reflective liquid crystal panel and including a polarizer and a Pancharatnam-Berry phase diffraction grating.

2. The reflective liquid crystal display device according to claim 1,
wherein the optical element includes, in order from its reflective liquid crystal panel side toward its observer side, the polarizer, a λ/4 plate, and the Pancharatnam-Berry phase diffraction grating.

3. The reflective liquid crystal display device according to claim 2,
wherein the polarizer is a linear polarizer or a circular polarizer.

4. The reflective liquid crystal display device according to claim 1,
wherein the optical element includes, in order from its reflective liquid crystal panel side toward its observer side, a λ/4 plate, the Pancharatnam-Berry phase diffraction grating, and a circular polarizer as the polarizer.

5. The reflective liquid crystal display device according to claim 1,
wherein the optical element includes, in order from its reflective liquid crystal panel side toward its observer side, the Pancharatnam-Berry phase diffraction grating, and a circular polarizer as the polarizer, and does not include a λ/4 plate between the reflective liquid crystal panel and the Pancharatnam-Berry phase diffraction grating.

6. The reflective liquid crystal display device according to claim 1,
wherein the Pancharatnam-Berry phase diffraction grating includes a phase difference layer containing a cured product of a polymerizable liquid crystal,
a slow axis of the polymerizable liquid crystal, in a plane of the phase difference layer, rotates periodically in an x-axis direction from a first end to a second end of the phase difference layer and does not rotate periodically in a y-axis direction orthogonal to the x-axis direction, and
the x-axis direction corresponds to a left-right direction of the reflective liquid crystal panel.

7. The reflective liquid crystal display device according to claim 1,
wherein the Pancharatnam-Berry phase diffraction grating includes a phase difference layer that introduces a phase difference Δnd satisfying the following Formula 1 or Formula 2 to wavelengths λ of 450 nm, 550 nm, and 650 nm:
$${sin}^{4} ( \frac{Δ nd π}{λ} ) > \frac{1}{4 π} \qquad ( Formula 1 )$$
$${sin}^{2} ( \frac{Δ nd π}{λ} ) {cos}^{2} ( \frac{Δ nd π}{λ} ) > \frac{1}{4 π} . \qquad ( Formula 2 )$$

8. The reflective liquid crystal display device according claim 1,
wherein the Pancharatnam-Berry phase diffraction grating includes a phase difference layer containing a cured product of a polymerizable liquid crystal,
a slow axis of the polymerizable liquid crystal, in a plane of the phase difference layer, rotates periodically in an x-axis direction from a first end to a second end of the phase difference layer, and
a molecular alignment pattern Φ(x) [°] as an alignment direction of the polymerizable liquid crystal at a position a distance x [μm] away in the x-axis direction from a position where the slow axis of the polymerizable liquid crystal is parallel to the x-axis direction satisfies the following Formula 3:
$$∅ ( x ) = \frac{180 °}{Λ} x + m sin ( nx + A ) \qquad ( Formula 3 )$$
wherein Λ represents a pitch [μm] at which the slow axis of the polymerizable liquid crystal rotates 180° in the plane of the phase difference layer, and m, n, and A are each an arbitrary constant.

9. The reflective liquid crystal display device according to claim 1, further comprising a diffusion layer in the observer side of the optical element or between members constituting the optical element.

10. The reflective liquid crystal display device according to claim 1, further comprising a refractive element in the observer side of the optical element.
